(19) United States
(12) Patent Application Publication
(10) Pub. No.: US 2007/0171334 A1
(43) Pub. Date: Jul. 26, 2007

(54) Wide viewing angle liquid crystal display and a method for achieving wide viewing angle effect

(75) Inventors: Shie-Chang Jeng, Hsinchu (TW); Wei-Ting Hsu, Hsinchu (TW); Chi-Chang Liao, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 11/403,818

(22) Filed: Apr. 14, 2006

(30) Foreign Application Priority Data
Jan. 26, 2006 (TW) 95103001

(51) Int. Cl. G02F 1/1333

(52) U.S. Cl. 349/86

(57) ABSTRACT

This invention provides a wide viewing angle liquid crystal display and a method for achieving wide viewing angle effect. The invention adds conductive nanoparticles in a liquid crystal layer of the present liquid crystal display. When a driving voltage is applied on the present liquid crystal display, an electric field applied on the liquid crystal layer is distorted by the conductive nanoparticles dispersed in the liquid crystal layer. A non-uniform electric field is hence formed in the liquid crystal layer and the liquid crystal molecules are prone to multi-directional alignments. As such, a wide viewing angle effect can be achieved.

### BACKGROUND OF THE INVENTION

1. Field of the Invention

The present invention relates to a liquid crystal display, and more particularly to a wide viewing angle liquid crystal display.

2. Description of the Related Art

A liquid crystal display (LCD) has been a popular display device. However, there are many kinds of research subjects for display technology still keeping going. Insufficiency of viewing angle is a natural defect existing in a traditional LCD. Due to the demand of high-quality LCDs by consumers, a wide viewing angle LCD becomes a main trend in research and manufacture area. In addition to attach a compensation film to improve the phenomenon of light leakage at the dark state, several methods, such as Multi-Domains Vertical Alignment (MVA), In-Plane Switching (IPS), and Fringe Field Switching (FFS), have been implemented to improve wide viewing angle by aligning liquid crystal molecules with optical symmetry when external voltage is applied on.

In such recent designs to increase the wide viewing angle, multiple photolithography processes are required to form protrusions or patterned electrodes on the substrates to make the orientation of the liquid crystal molecules having optical symmetry as shown in FIG. 3 and FIG. 4.

FIG. 3 is a schematic cross-sectional view of a traditional MVA LCD. The traditional MVA LCD utilizes protrusions 101, or named bumps, on the upper and lower substrates 100a and 100b to form pre-tilted alignment of liquid crystal molecules 102. The dielectric constant of the bump materials is smaller than that of the liquid crystal molecules 102, and by which the design of the multi-domain divisions is to improve the wide viewing angle effect at the bright state. The pitch of bumps needs to be less than 30 μm, and therefore the aperture ratio is not too high.

FIG. 4 is a schematic cross-sectional view of another traditional MVA LCD. The traditional MVA LCD forms inter-disposed patterned indium-tin oxide (ITO) electrodes 103 on the upper and lower substrates 100a and 100b. In this design, the pre-tilted directions of the liquid crystal molecules 102 are driven by fringe electric field 104. The multi-domain division is obtained and the manufacturing process is simplified. In 1999, the techniques of MVA were only to make bumps on the upper substrate and ITO on the lower substrate. The processes were simple, and the aperture ratio was higher. After that, the known color filter manufacture process is adopted to overlap red, green and blue colors, and as the design of the spacer. The processes were simple, and the contrast ratio was higher.

However, the above techniques need additional multiple photolithography processes to form the protrusions 101 or increase the manufacturing steps to make the patterned ITO electrode 103 so as to achieve the wide viewing angle effect. Accordingly, it is desired to provide a simple and effective method to achieve wide viewing angle effect of the liquid crystal display.

### SUMMARY OF THE INVENTION

One objective of the present invention is to provide a wide viewing angle liquid crystal display, in which non-uniform electric field is formed in a liquid crystal layer of the present liquid crystal display by dispersing conductive nanoparticles in the liquid crystal layer so as to achieve the wide viewing angle effect.

For achieving the above objective, the present invention provides a wide viewing angle liquid crystal display, comprising a first substrate, a second substrate, a first electrode layer formed on the first substrate, a second electrode layer formed on the second substrate opposite to the first electrode layer, and a liquid crystal layer formed between the first electrode layer and second electrode layer. A plurality of conducting particles is dispersed in the liquid crystal layer so that a non-uniform electric field is formed by the conducting particles in the liquid crystal layer and the wide viewing angle effect is achieved when driving voltages are applied in the first electrode layer and second electrode layer.

In one another aspect, the present invention provides a method for achieving wide viewing angle effect of a liquid crystal display, in which a plurality of conducting particles is dispersed in a liquid crystal layer of the present liquid crystal display so that a non-uniform electric field is formed by the conducting particles in the liquid crystal layer, and the wide viewing angle effect is achieved when driving voltage is applied on the liquid crystal layer.

It is preferable that the diameters of the conducting particles are not more than 200 nm in the present invention.

It is preferable that the content of the conducting particles is not more than ten percentage of total mass of the liquid crystal layer in the present invention.

It is preferable that the conducting particles are formed by solid conductive materials in the present invention.

It is preferable that the conducting particles are formed by an insulating material wrapped with a conductive layer in the present invention.

It is preferable that the wide viewing angle effect of the present liquid crystal display is optimized by controlling a dispersive density of the conducting particles in the liquid crystal layer.

It is preferable that the liquid crystal layer of the present invention contains negative dielectric anisotropic liquid crystal molecules.

The present invention utilizes the conducting particles dispersed in the liquid crystal layer to achieve wide viewing angle effect. The manufacturing steps of the present liquid crystal display are simple and easy to be accomplished. The present invention can resolve the problem of using additional multi-photolithography processes to form protrusions and patterned ITO electrodes on the substrate in order to achieve the wide viewing angle effect. As such, the present invention can reduce the manufacturing cost of the liquid crystal display and increase the yield.

### BRIEF DESCRIPTION OF THE DRAWINGS

FIG. 1 shows a schematic cross-sectional view of a wide viewing angle liquid crystal display of the present invention.

FIG. 2A shows a schematic cross-sectional view of a kind of conducting particles of the present invention.

FIG. 2B shows a schematic cross-sectional view of another kind of conducting particles of the present invention.

FIG. 3 shows a schematic cross-sectional view of a conventional Multi-Domains Vertical Alignment liquid crystal display.

FIG. 4 shows a schematic cross-sectional view of another conventional Multi-Domains Vertical Alignment liquid crystal display.

### DETAILED DESCRIPTION OF THE PREFERRED EMBODIMENTS

The present invention provides a wide viewing angle liquid crystal display, mainly comprising a first substrate, a second substrate opposite to the first substrate, a first optical film on the outside surface of the first substrate and a first electrode layer on the inside surface of the first substrate, a second electrode layer on the inside surface of the second substrate and a second optic film on the outside surface of the second substrate, a first alignment layer disposed below the first electrode layer, a second alignment layer disposed above the second electrode layer, and a liquid crystal layer sandwiched by the first alignment layer and second alignment layer. The electric field is distorted by the conductive nanoparticles dispersed in the liquid crystal layer while driving voltages applying to the first electrode layer and second electrode layer. Equal potential lines in the liquid crystal layer are twisted. The liquid crystal molecules are aligned along the equal potential lines such that the liquid crystal molecules align toward multiple directions, and having various orientations in the liquid crystal layer. The view angle is thus increased.

The present wide viewing angle liquid crystal display and the method for achieving wide viewing angle effect will be described in detail by way of following embodiments and accompanying drawings.

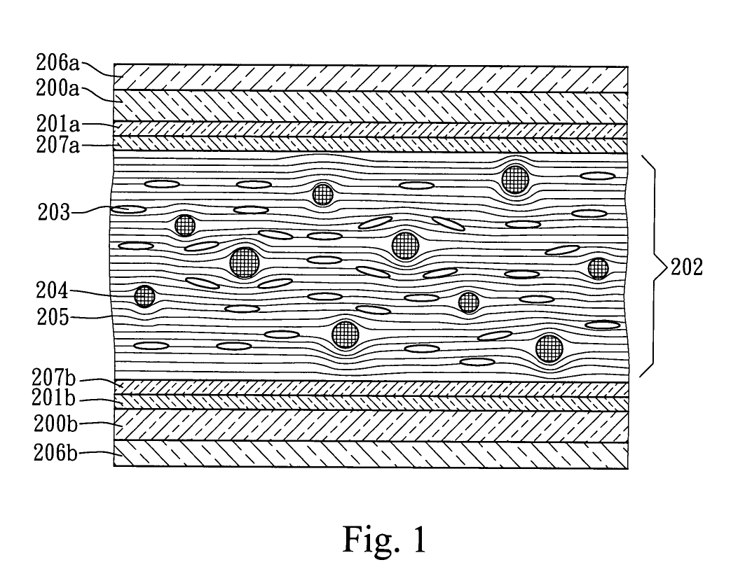

Referring to FIG. 1, which is a schematic cross-sectional view of the wide viewing angle liquid crystal display of the present invention, the wide viewing angle liquid crystal display comprises a first substrate 200a, a second substrate 200b opposite to the first substrate 200a, a first optic film 206a on the upper surface of the first substrate 200a and a first electrode layer 201a on the lower surface of the first substrate 200a, a second electrode layer 201b on the upper surface of the second substrate 200b and a second optic film 206b on the lower surface of the second substrate 200b, a first alignment layer 207a below the first electrode layer 201a, a second alignment layer 207b above the second electrode layer 201b, a liquid crystal layer 202 sandwiched by the first alignment layer 207a and the second alignment layer 207b. The liquid crystal layer 202 contains liquid crystal molecules 203 and a predetermined amount of conducting particles 204.

When driving voltages apply to the first electrode layer 201a and second electrode layer 201b, the electric field surrounding the conducting particles 204 in the liquid crystal layer 202 is influenced and distorted by the conducting particles 204. A non-uniform electric field is formed in the liquid crystal layer 202, and thus the equal potential lines 205 in the liquid crystal layer 202 are twisted. The liquid crystal molecules 203 are aligned along the equal potential lines 205. Therefore the liquid crystal molecules 203 have various orientations. The viewing angle is increased. As such, the present liquid crystal display can provide wide view angle effect.

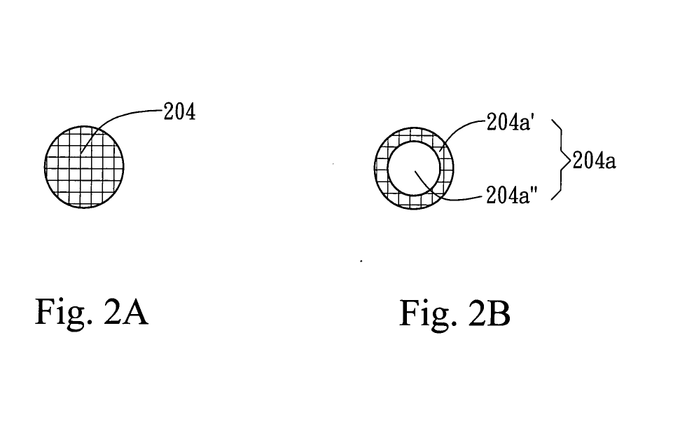

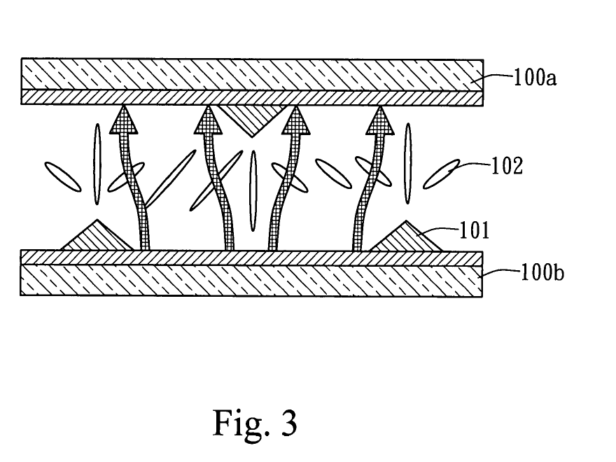

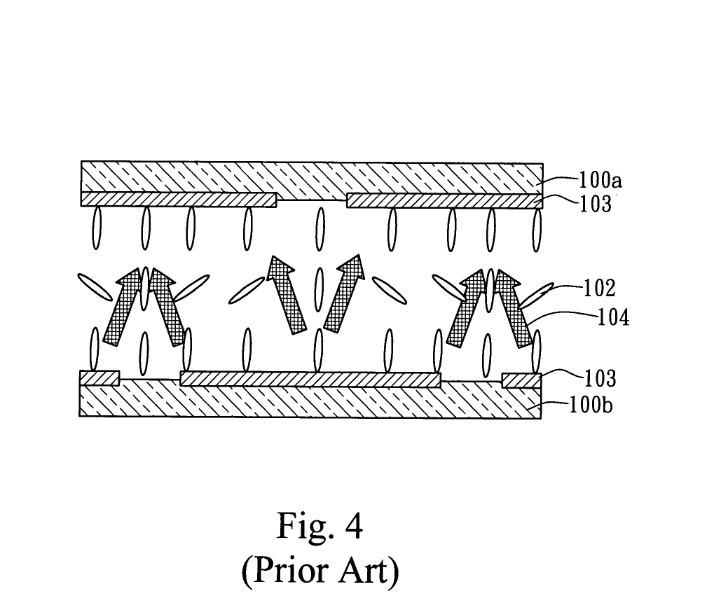

The liquid crystal molecules 203 are negative dielectric anisotropic liquid crystal molecules. The conducting particles 204 dispersed in the liquid crystal layer 202 can be solid conducting particles 204 or formed by an insulating material 204a″ wrapped with a conductive layer 204a′, referring FIG. 2A and FIG. 2B. To avoid the first electrode layer 201a and second electrode layer 201b becoming short circuit, the diameters of the conducting particles 204 in the liquid crystal layer 202 can not be too large and the content of the conducting particles 204 in the liquid crystal layer 202 can not be too high. The preferred diameters of the conducting particles 204 are not more than 200 nm, and the preferred content of the conducting particles 204 dispersed in the liquid crystal layer 202 is not more than 10% by mass relative to the total mass of the particles and liquid crystal molecules. The wide viewing angle effect of the liquid crystal display is optimized by controlling a dispersive density of the conducting particles 204 in the liquid crystal layer 202.

Additionally, the present invention provides a method for achieving wide viewing angle effect of the liquid crystal display. An appropriate amount of the conducting particles 204 is dispersed in the liquid crystal layer 202. The electric field is influenced and distorted by the conducting particle 204 when the driving voltages apply to the liquid crystal layer 202. The equal potential lines 205 in the liquid crystal layer 202 are therefore twisted. The liquid crystal molecules 203 in the liquid crystal layer 202 are aligned along the equal potential lines 205. As such, the liquid crystal molecules 203 show various orientations in the liquid crystal layer 202. The view angle of the liquid crystal display is increased.

The present invention also utilizes the well-known optical films attached on the outside of the substrates and the alignment layers coated on the inside of the substrates to achieve better effect. The present invention does not require additional multiple photolithography processes to form the protrusions and patterned ITO on the substrates to achieve the wide viewing angle effect. The manufacturing cost is reduced and the yield is increased. The present invention is a simple and effective method to achieve the wide viewing angle effect of the liquid crystal display.

While the invention has been described by way of examples and in terms of preferred embodiments, it is to be understood that those who are familiar with the subject art can carry out various modifications and similar arrangements and procedures described in the present invention and also achieve the effectiveness of the present invention. Hence, it is to be understood that the description of the present invention should be accorded with the broadest interpretation to those who are familiar with the subject art, and the invention is not limited thereto.

What is claimed is:

1. A wide viewing angle liquid crystal display, comprising:
a first substrate;
a second substrate;
a first electrode layer formed on said first substrate;
a second electrode layer formed on said second substrate opposite to said first electrode layer; and
a liquid crystal layer formed between said first electrode layer and said second electrode layer, wherein a predetermined amount of conducting particles is dispersed in said liquid crystal layer such that a non-uniform electric field is formed by said conducting particles in said liquid crystal layer when driving voltages are applied in said first electrode layer and said second electrode layer.

2. The wide viewing angle liquid crystal display as claimed in claim 1, wherein the diameters of said conducting particles are not more than 200 nm.

3. The wide viewing angle liquid crystal display as claimed in claim 1, wherein the content of said conducting particles is not more than ten percentage of total weight of said liquid crystal layer.

4. The wide viewing angle liquid crystal display as claimed in claim 2, wherein the content of said conducting particles is not more than ten percentage of total mass of said liquid crystal layer.

5. The wide viewing angle liquid crystal display as claimed in claim 1, wherein said liquid crystal layer contains negative dielectric anisotropic liquid crystal molecules.

6. The wide viewing angle liquid crystal display as claimed in claim 1, wherein said conducting particles are formed by solid conductive materials.

7. The wide viewing angle liquid crystal display as claimed in claim 1, wherein said conducting particles are formed by an insulating material wrapped with a conductive layer.

8. The wide viewing angle liquid crystal display as claimed in claim 1, wherein the wide viewing angle effect of said wide viewing angle liquid crystal display is optimized by controlling a dispersive density of said conducting particles.

9. A method for achieving wide viewing angle effect of a liquid crystal display, wherein a predetermined amount of conducting particles is dispersed in a liquid crystal layer disposed in said liquid crystal display such that a non-uniform electric field is formed by said conducting particles dispersed in said liquid crystal layer when driving voltage is applied on said liquid crystal layer.

10. The method for achieving wide viewing angle effect of a liquid crystal as claimed in claim 9, wherein the diameters of said conducting particles are not more than 200 nm.

11. The method for achieving wide viewing angle effect of a liquid crystal display as claimed in claim 9, wherein the content of said conducting particles is not more than ten percentage of total mass of said liquid crystal layer.

12. The method for achieving wide viewing angle effect of a liquid crystal display as claimed in claim 10, wherein the content of said conducting particles is not more than ten percentage of total mass of said liquid crystal layer.

13. The method for achieving wide viewing angle effect of a liquid crystal display as claimed in claim 9, wherein said liquid crystal layer contains negative dielectric anisotropic liquid crystal molecules.

14. The method for achieving wide viewing angle effect of a liquid crystal layer as claimed in claim 9, wherein said conducting particles are formed by solid conductive materials.

15. The method for achieving wide viewing angle effect of a liquid crystal display as claimed in claim 9, wherein said conducting particles are formed by an insulating material wrapped with a conductive layer.

16. The method for achieving wide viewing angle effect of a liquid crystal display as claimed in claim 9, wherein the wide viewing angle effect of said liquid crystal display is optimized by controlling a dispersive density of said conducting particles.
